(19) United States
(12) Patent Application Publication
(10) Pub. No.: US 2022/0009324 A1
(43) Pub. Date: Jan. 13, 2022

(54) ATTACHMENT STRUCTURE OF DOOR WIRING MODULE

(71) Applicants: AutoNetworks Technologies, Ltd., Mie (JP); Sumitomo Wiring Systems, Ltd., Mie (JP); SUMITOMO ELECTRIC INDUSTRIES, LTD., Osaka (JP)

(72) Inventors: Koji YAMAGUCHI, Mie (JP); Housei MIZUNO, Mie (JP); Yoshitaka KURODA, Mie (JP)

(73) Assignees: AutoNetworks Technologies, Ltd., Mie (JP); Sumitomo Wiring Systems, Ltd., Mie (JP); SUMITOMO ELECTRIC INDUSTRIES, LTD., Osaka (JP)

(21) Appl. No.: 17/429,232

(22) PCT Filed: Jan. 31, 2020
(86) PCT No.: PCT/JP2020/003583

§ 371 Date: Aug. 6, 2021

(30) Foreign Application Priority Data
Feb. 20, 2019 (JP) 2019-028364

(51) Int. Cl. B60J 5/04; B60R 16/02; H02G 3/30; H02G 11/00

(52) U.S. Cl. CPC B60J 5/0412; H02G 11/00; H02G 3/30; B60R 16/0207

(57) ABSTRACT

A door wiring module includes: a door planar member incorporated into a door of a vehicle to be able to cover an operation opening formed in the door panel; and a wiring member attached to the door planar member, wherein the door planar member includes a first assembled part assembled to a first region in the door panel and a second assembled part assembled to a second region different from the first region in the door panel, and in a state where the first assembled part is assembled to the first region in the door panel, the second assembled part is movably provided in a position other than the second region in the door panel so as to be able to open a part of the operation opening formed in the second region.

### TECHNICAL FIELD

The present disclosure relates to a door wiring module.

### BACKGROUND ART

Patent Document 1 discloses a technique of assembling a wire harness to a door body provided with an opening for operation referred to as an operation window (also referred to as a service hole, for example). In Patent Document 1, the wire harness is assembled to the door body, and a waterproof sheet covers the operation window. Accordingly, when the wire harness is assembled to the door body, an operation can be performed using the operation window. Patent Document 1 describes an operation of fitting a connector provided in an end portion of the wire harness as the operation using the operation window. Also performed as the operation using the operation window is an operation of inserting a grommet attached to a portion of the wire harness extending on a vehicle body side into a hole formed in the door body.

### PRIOR ART DOCUMENTS

### Patent Documents

Patent Document 1: Japanese Patent Application Laid-Open No. 9-76837

Patent Document 2: Japanese Patent Application Laid-Open No. 11-198742

### SUMMARY

### Problem to be Solved by the Invention

Desired is that the operation of assembling the wire harness to the door body and the operation of covering the operation window are simplified.

Thus, it is an object to provide a technique capable of simplifying an operation of assembling a wiring member to a door panel and an operation of covering an operation opening formed in the door panel.

### Means to Solve the Problem

A door wiring module according to the present disclosure includes: a door planar member incorporated between a door panel and a design trim to be able to cover an operation opening formed in the door panel in a door of a vehicle; and a wiring member attached to the door planar member, wherein the door planar member includes a first assembled part assembled to a first region in the door panel and a second assembled part assembled to a second region different from the first region in the door panel, and in a state where the first assembled part is assembled to the first region in the door panel, the second assembled part is movably provided in a position other than the second region in the door panel so as to be able to open a part of the operation opening formed in the second region.

### Effects of the Invention

According to the present disclosure, an operation of assembling a wiring member to a door panel and an operation of covering an operation opening formed in the door panel can be simplified.

### BRIEF DESCRIPTION OF DRAWINGS

FIG. 1 is an explanation drawing illustrating an outline of a door into which a door wiring module is incorporated.

FIG. 2 is a schematic side view illustrating a door into which a door wiring module according to an embodiment 1 is incorporated,

FIG. 3 is a cross-sectional view of the door wiring module cut along a III-III line in FIG. 2.

FIG. 4 is an explanation drawing illustrating a state where an operation opening is opened.

FIG. 5 is an explanation drawing illustrating a state where the operation opening is opened.

FIG. 6 is a schematic side view illustrating a modification example of the operation opening.

FIG. 7 is a schematic side view illustrating another modification example of the operation opening.

FIG. 8 is a schematic side view illustrating a modification example of a position where a hinge part is provided.

FIG. 9 is a schematic side view illustrating a door into which a door wiring module according to an embodiment 2 is incorporated.

FIG. 10 is a schematic side view illustrating a door planar member in the door wiring module according to the embodiment 2.

FIG. 11 is a schematic plan view illustrating a modification example of a locking part.

### DESCRIPTION OF EMBODIMENTS

[Description of embodiment of present disclosure] Embodiments of the present disclosure are listed and described firstly.

A wiring module according to the present disclosure is as follows.

(1) A door wiring module includes: a door planar member incorporated between a door panel and a design trim to be able to cover an operation opening formed in the door panel in a door of a vehicle; and a wiring member attached to the door planar member, wherein the door planar member includes a first, assembled part assembled to a first region in the door panel and a second assembled part assembled to a second region different from the first region in the door panel, and in a state where the first assembled part is assembled to the first region in the door panel, the second assembled part is movably provided in a position other than the second region in the door panel so as to be able to open a part of the operation opening formed in the second region.

The wiring member is attached to the door planar member, thus the wiring member can also be assembled at a time of assembling the door planar member to the door panel. In the state where the first assembled part is assembled to the first region in the door panel, the second assembled part is provided to be movable from the second region in the door panel so as to be able to open the part of the operation opening formed in the second region, thus an operation using the operation opening can be performed in this state. The second assembled part is assembled to the second region after the operation, thereby being able to cover the operation opening formed in the door panel, thus the operation of covering the operation opening formed in the door panel can be easily performed. According to these configurations, the operation of assembling the wiring member to the door and the operation of covering the operation opening formed in the door can be simplified.

Herein, the door planar member is a planar member having a dimension in a thickness direction smaller than a dimension in a planar direction.

(2) It is preferable that the door planar member further includes a hinge part connecting the first assembled part and the second assembled part to be able to relatively bend them in a front-back direction. The reason is that the second assembled part is bended with respect to the first assembled part by the hinge part in a state where the first assembled part is assembled to the door panel, thereby being able to open the operation opening formed in the door panel. Furthermore, when the second assembled pad is assembled to the door panel after the operation using the operation opening, the second assembled part is bended with respect to the first assembled part by the hinge part, thus an assembling posture can be easily achieved.

(3) It is preferable that the door planar member further includes a locking part detachably connecting the first assembled part and the second assembled part. The reason is that the operation opening formed in the door panel can be opened when the second assembled part is not connected to the first assembled part in the state where the first assembled part is assembled to the door panel. Furthermore, when the second assembled part is assembled to the door panel, the second assembled pan can be connected to the first assembled part using the locking part, thereby being easily assembled to the door panel. The number of positions where the second assembled part is directly fixed to the door panel can be reduced.

(4) It is sufficient that the wiring member is fixed only one of the first assembled part and the second assembled part. The reason is that when only the first assembled part in the first assembled part and the second assembled part is assembled to the door panel and the operation opening formed in the door panel is opened, load on the wiring member caused by bending, for example, is suppressed.

[Details of Embodiment of Present Disclosure]

Specific examples of a door wiring module of the present disclosure are described hereinafter with reference to the drawings. The present invention is not limited to these examples, but is indicated by claims, and it is intended that meanings equivalent to claims and all modifications within a scope of claims are included.

### Embodiment 1

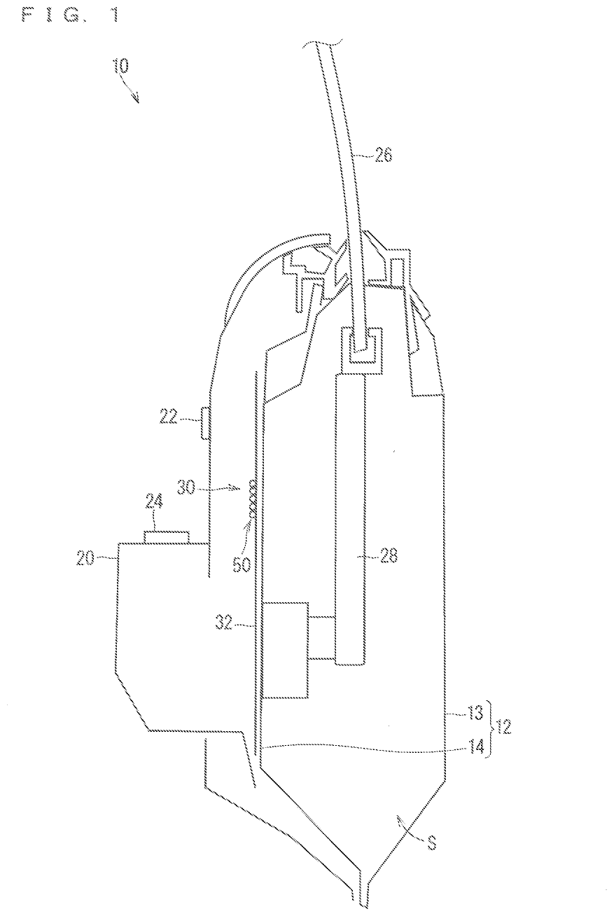

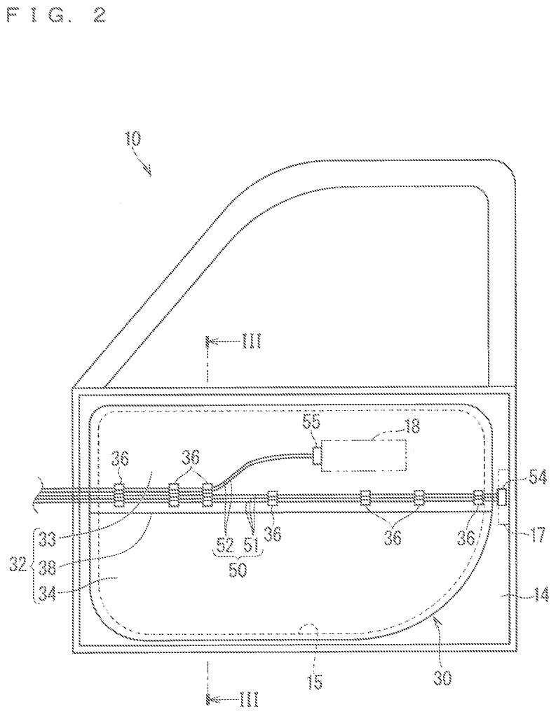

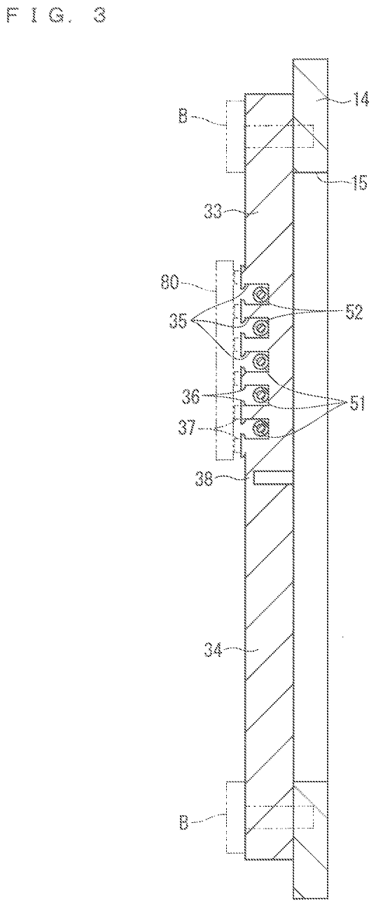

A door wiring module according to an embodiment 1 is described hereinafter. FIG. 1 is an explanation drawing illustrating an outline of a door 10 into which a door wiring module 30 is incorporated. FIG. 2 is a schematic side view illustrating the door wiring module 30 according to the embodiment 1. FIG. 3 is a cross-sectional view of the door wiring module cut along a line in FIG. 2.

The door 10 is formed into a flat shape as a whole, and is a part openable and closable to partition an inner side and outer side of a vehicle. The door 10 is assumed to be a driver side door, a passenger's side door, and a rear seat door, for example. The door 10 includes a door panel 12, a design trim 20, and the door wiring module 30.

The door panel 12 includes an outer panel 13 and an inner panel 14. The outer panel 13 is provided in a part of the door 10 facing the outer side of the vehicle to constitute au appearance of the vehicle together with a body. The inner panel 14 is provided on a vehicle interior side of the outer panel 13. An operation opening 15 is formed in the inner panel 14. The door wiring module 30 is attached to the operation opening 15 to close the operation opening 15.

The design trim 20 is a part provided in a part of the door 10 facing the inner side of the vehicle to constitute the interior of the vehicle. A door handle 22 and an operation part 24 of an in-vehicle apparatus, for example, are attached to the design trim 20.

The door wiring module 30 includes a door planar member 32 and a wiring member 50. The wiring member 50 is fixed to the door planar member 32. The door planar member 32 is incorporated into the door 10, thus the wiring member 50 is also incorporated into the door 10.

The door planar member 32 is a planar member incorporated between the door panel 12 and the design trim 20 in the door 10 of the vehicle. The planar member herein indicates a member having a thickness dimension smaller than a dimension in a planar direction (two directions perpendicular to a thickness direction) and two-dimensionally spread. It needs not necessarily be flat in a front-back direction (the thickness direction), but a convex-concave portion may occur in the front-back direction,

The door planar member 32 is a flat member having an area substantially equal to or larger than the operation opening 15. The door planar member 32 is provided to be able to cover the operation opening 15 formed in the door panel 12 in a stale of being assembled to a predetermined position of the door 10 of the vehicle. Accordingly, the door planar member 32 can partition the inner side and outer side of the vehicle. The door planar member 32 is assembled to the inner panel 14 by a screw damp or a locking structure in a state of being located in a predetermined position covering the operation opening 15 of the inner panel 14. For example, as illustrated in FIG. 3, when a part of a peripheral edge portion of the door planar member 32 overlapping with the inner panel 14 is screwed to the inner panel 14 using a screw B, for example, a gap therebetween can be practicably covered.

A space S is formed between the outer panel 13 and the inner panel 14 and between the outer panel 13 and the door planar member 32 in a state where the door planar member 32 is assembled to the inner panel 14. A window 26 of the door 10 can be housed in this space S. The window 26 exposed to a rainwater environment is housed in the space S, and a slit-like opening through which the window 26 goes in and out is formed on an upper side of the space S. Thus, the space S is a space which water may enter. The space S is a space which may be connected to an outer space, thus is also a space which a wind noise, for example, may enter from outside. Thus, the door planar member 32 is provided as a member for completely partitioning a vehicle interior space and an outer space with the inner panel 14.

The door planar member 32 includes a plurality of assembled parts 33 and 34 assembled to different regions in the door panel 12. In the description herein, the assembled part 33 is a first assembled part 33 assembled to a first region in the door panel 12, and the assembled part 34 is a second assembled part 34 assembled to a second region different from the first region in the door panel 12. In a state where the first assembled part 33 is assembled to the first region in the door panel 12, the second. assembled part 34 is movably provided in a position other than the second region in the door panel 12 so as to be able to open a part of the operation opening 15 formed in the second region.

When the operation opening 15 is opened, it is sufficient that the operation opening 15 is opened so that an operator can perform an operation required in the space S in the door panel 12 after the first assembled part 33 assembled. The whole operation opening 15 may be opened or only a part of the operation opening 15 may be opened. The operation opening 15 is preferably opened so that an operator can insert his/her hand. therein to perform an operation in the space S. From this viewpoint, the operation opening 15 is considered an opening into which an operator can insert his/her hand to perform an operation in the space S. The operation in the space S performed by the operator is considered an operation of fitting a connector connected to an air-bag sensor in the space 5, an operation of attaching a grommet at a time of bringing the wiring member 50 out of the space S, or an operation of grasping and taking out a component disposed in the space S, for example.

it sufficient that the first assembled part 33 and the second assembled part 34 has rigidity to be hardly headed in a front-back direction. Accordingly, when the door planar member 32 is assembled to the door panel 12, an edge part thereof is hardly beaded, thus the door planar member 22 is easily kept in a spread shape, and can be easily assembled. For example, the first assembled part 33 and the second assembled part 34 are formed to have higher rigidity than the wiring member 50.

A holding groove 35 in which the wiring member 50 is housed is formed on a main surface of the door planar member 32. The holding groove 35 is formed in accordance with a wring stale of the wiring member 50. The wiring member 50 is housed in and held by the holding groove 35, thereby being wired on and held by the door planar member 32. Herein, the holding groove 35 is formed in the first assembled part 33.

In the description herein, the first assembled part 33 and the second assembled part 34 are connected to each other. Particularly in the description herein, the first assembled part 33 and the second assembled part 34 are connected to each other by a hinge part 38. Accordingly, the door planar member 32 further includes the hinge part 38 connecting the first assembled part 33 and the second assembled part 34 to each other.

The hinge part 38 is a part connecting the first assembled part 33 and the second assembled part 34 to be able to relatively bend them in a front-back direction. In the example illustrated in FIG. 3, the hinge part 38 is a part formed into a thin-walled shape and integrally molded with the first assembled part 33 and the second assembled part 34.

Needless to say, the hinge part 38 may have a configuration other than the thin-walled shape. For example, also applicable is a configuration that the hinge part 38 includes a shaft part integrally molded with one of the first assembled part 33 and the second assembled part 34 and a shaft bearing part integrally molded with the other one of the first assembled part 33 and the second assembled part 34 to rotatably support the shaft part. The hinge part 38 may include a component molded separately from the first assembled part 33 and the second assembled part 34. Considered in this case is a configuration that, for example, the hinge part 38 includes a component with a shaft part attached to one of the first assembled part 33 and the second assembled part 34 and a component with a shaft bearing part attached to the other one of the first assembled part 33 and the second assembled part 34. Also considered is a configuration that, for example, the hinge part 38 includes a shaft bearing part formed in each of the first assembled part 33 and the second assembled part 34 and a component with a shaft part attached to the shaft bearing part formed in each of the first assembled part 33 and the second assembled part 34.

The first assembled part 33 and the second assembled part 34 in the door planar S member 32 are components in which resin or metal, for example, as a material is molded. Herein, the door planar member 32 is made of resin or metal as a material, and molded into a shape including the first assembled part 33, the second assembled part 34, and the thin-walled hinge part 38. The door planar member 32 may be molded by pouring a molten material into a mold or by performing a press molding on a planar material using a mold.

The wiring member 50 is an electrical wiring provided in the door 10 and connected to the electrical components 17 and 18 provided in the door 10. A part of the wiring member 50 along an extension direction is wired on and held by the door planar member 32. The wiring herein indicates that the wiring member 50 is wired in a form corresponding to a wiring state at a time of being assembled to the door 10. Accordingly, the door planar member 32 is assembled to a predetermined position of the door 10, thus wiring of the part of the wiring member 50 wired on and held, by the door planar member 32 to the door 10 is completed.

Herein, a middle portion of the wiring member 50 along the extension direction is wired on and held by the door planar member 32. The wiring member 50 is fixed, to only one of the first assembled part 33 and the second assembled part 34.

Herein, a branch is formed in the wiring member 50. The branch part of the wiring member 50 is wired on and held by the door planar member 32. Accordingly, a branch shape of the branch part is maintained by the door planar member 32.

More specifically, the wiring member 50 includes a plurality of electrical wires 51 and 52. A covering wire having a core wire made up of a conductor with a covering around the core wire can be used as the electrical wires 51 and 52. The core wire may be a single core wire or a stranded wire. The plurality of electrical wires 51 and 52 are wired side by side on the door planar member 32.

Herein, the plurality of electrical wires 51 and 52 include a first electrical wire 51 and a second electrical wire 52. In the example illustrated in FIG. 2, the wiring member 50 is made up of the three first electrical wires 51 and the two second electrical wires 52, however, the number of the first electrical wires 51 and second electrical wires 42 is not limited thereto but is appropriately set in accordance with an apparatus to which they are connected, for example. The first electrical wire 51 and the second electrical wire 52 are collected in a parallel state on each one end side. One end portions of the first electrical wire 51 and the second electrical wire 52 are connected to the wiring member 50 on a side of a vehicle body, for example. Accordingly, the electrical components 17 and 18 provided in the door 10 receive a power supply from a battery mounted to the vehicle body and supplies and receives a signal to and from an ECU or a gateway mounted to the vehicle body. In the example illustrated in FIG. 2, one end portions of the first electrical wire 51 and the second electrical wire 52 extend to an outer side of the door 10. One end portions of the first electrical wire 51 and the second electrical wire 52 are assembled to extend from the door 10 to the vehicle body, and are connected to the wiring member on the side of the vehicle body, for example. Needless to say, one end portions of the first electrical wire 51 and the second electrical wire 52 may be housed in the door 10.

The first electrical wire 51 and the second electrical wire 52 branch off in middle portions in the extension direction. The branch part thereof is located on the door planar member 32. Connectors 54 and 55 are attached to the other end portions of the first electrical wire 51 and the second electrical wire 52, and are connected to the electrical components 17 and 18 via the connectors 54 and 55. The first electrical wire 51 is connected to the electrical component 17 incorporated into the back side of the door 10, for example, a door lock-unlock motor. For example, the second electrical wire 52 is connected to the electrical component 18 incorporated into a middle portion of the door 10 such as a motor driving a window open-close jig 28 for opening and closing the window 26 and various switches, for example.

The first electrical wire 51 and the second electrical wire 52 are held in the holding groove 35. Herein, the holding groove 35 is formed so that the number and a parallel state thereof correspond to the plurality of electrical wires 51 and 52. The plurality of electrical wires 51 and 52 are individually held in the plurality of holding grooves 35. However, the plurality of electrical wires 51 and 52 may be housed in one holding groove 35.

In the example illustrated in FIG. 3, the wiring member 50 is housed in the holding groove 35 formed in the door planar member 32 in a state of not coming out of the holding groove 35, thus the door planar member 32 and the wiring member 50 are fixed to each other. For example, in the example illustrated in FIG. 3, a retaining part 36 is formed on an upper portion of the holding groove 35 (a portion on a side opposite to a bottom portion of the holding groove 35) as a configuration of preventing the wiring member 50 from coming out of the holding groove 35. The wiring member 50 is held and retained by the retaining part 36 in a state of being housed in the holding groove 35. thus can move in the holding groove 35 along a longitudinal direction of the wiring member 50.

The retaining part 36 is formed by crushing a protruding part 37 protruding to an upper side of a sidewall portion of the holding groove 35 by a fusion head 80, for example. Needless to say, the configuration of preventing the wiring member 50 from coming out of the holding groove 35 is not limited thereto, however, adoptable are various configurations such as a configuration that a member different from the door planar member 32 presses an upper portion of the holding groove 35 or a configuration of providing an adhesive agent in the holding, groove 35, for example. The retaining part 36 may cover the whole holding groove 35 along the extension direction of the wiring member 50. The retaining part 36 may cover a part of the holding groove 35 along the extension direction of the wiring member 50. In this case, it is sufficient that the plurality of retaining parts 36 are provided at intervals along the extension direction of the wiring member 50.

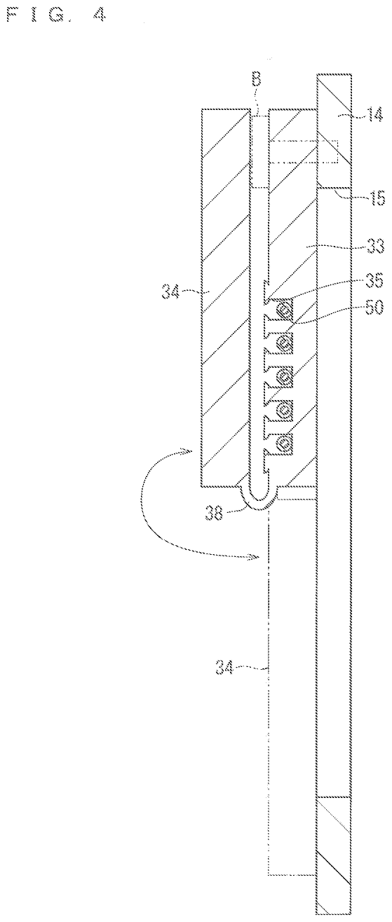

FIG. 4 is an explanation drawing illustrating a state where the operation opening 15 is opened. As illustrated in FIG. 4, the second assembled part 34 moves to a position other than the second region in a state where the first assembled part 33 is assembled to the first region, thus the operation opening 15 is opened. Herein, the second assembled part 34 rotationally moves around a rotational axis of the hinge part 38, thus the operation opening 15 is opened. In this state, the operator can perform the operation in the space S through the operation opening 15. The second assembled part 34 moves to the second region when the second assembled part 34 is assembled to the door panel 12 after the operation using the operation opening 15 is finished, thus the operation opening 15 is closed. Herein, the second assembled part 34 is bended with respect to the first assembled part 33 by the hinge part 38, thus the second assembled part 34 moves to the second region and takes an assembling posture.

At this time, when the wiring member 50 is fixed to only one of the first assembled part 33 and the second assembled part 34, load on the wiring member 50 caused by bending, for example, is suppressed in a case where only the first assembled part 33 in the first assembled part 33 and the second assembled part 34 is assembled to the door panel 12, the second assembled part 34 moves to a position other than the second region, and the operation opening 15 formed in the door panel 12 is opened.

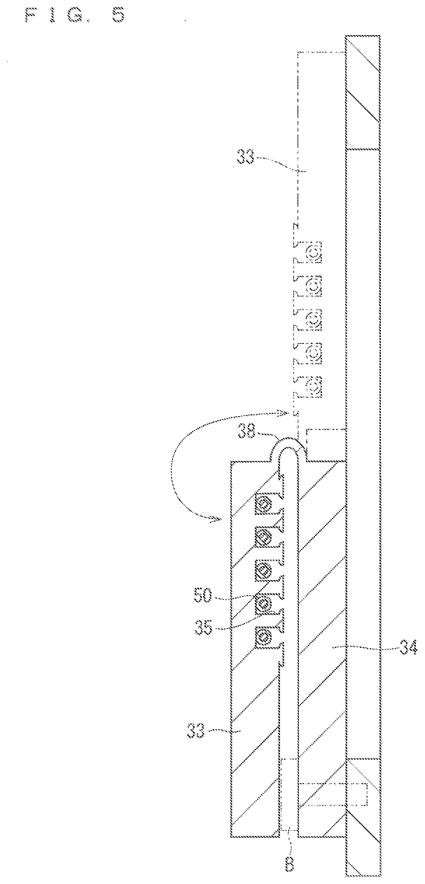

Also considered is that an order of assembling the plurality of assembled parts 33 and 34 is not determined in the door wiring module 30. Specifically, in the above example, the assembled part 33 is the first assembled part 33, and the assembled part 34 is the second assembled part 34, however, also considered is that they are assembled in a reverse order. That is to say, the assembled part 33 may be assembled after the assemble part 34 is assembled. In this case, the assembled part 34 is the first assembled part and the assembled part 33 is the second assembled part. A portion where the assembled part 34 is assembled is the first region and a portion where the assembled part 33 is assembled is the second region. Then, as illustrated in FIG. 5, the assembled part 33 rotationally moves around the rotational axis of the hinge part 38 in the state where the assembled part 34 is assembled, thus the operation opening 15 is opened.

In the example described above, only one operation opening 15 is formed in the inner panel 14, and this one operation opening 15 is covered by the first assembled part 33 and the second assembled part 34, however, the number and a shape of the operation opening 15 formed in the inner panel 14 are not limited thereto.

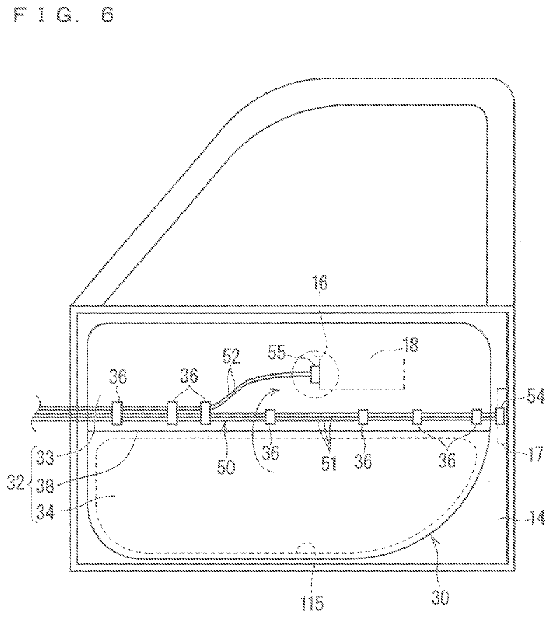

An operation opening 115 may be formed to be covered by only the second assembled part 34 in the first assembled part 33 and the second assembled part 34 as with the example illustrated in FIG. 6. When the operation opening 115 is formed smaller than the inner panel 14 in this manner, there may be a case where the other opening 16 different from the operation opening 115 is formed in the main surface of the inner panel 14. Considered as the other opening 16 is an opening for passing a part of the wiring member 50 from an outer side of the space S to an inner side thereof, for example. The other opening 16 may be or may not be covered by the door planar member 32.

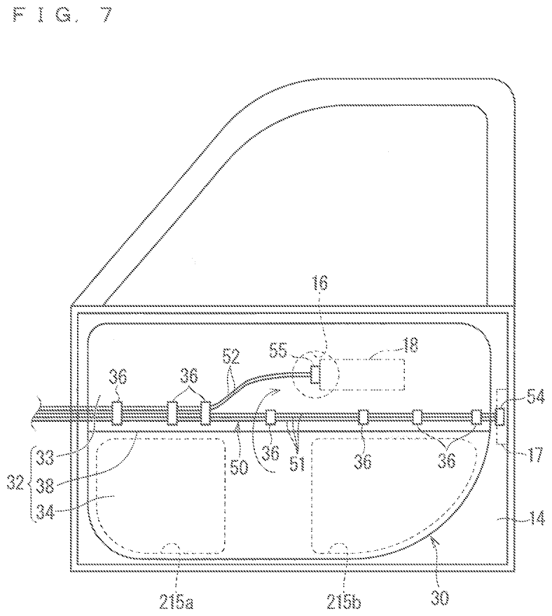

Also considered is that a plurality of operation openings 215a and 215b are formed in the inner panel 14 as with the example illustrated in FIG. 7. In this case, for example, one second assembled part 34 may be formed to be large enough to be able to cover the plurality of operation openings 215a and 215b. For example, the plurality of second assembled parts 34 may be provided to cover the plurality of operation openings 215a and 215, respectively.

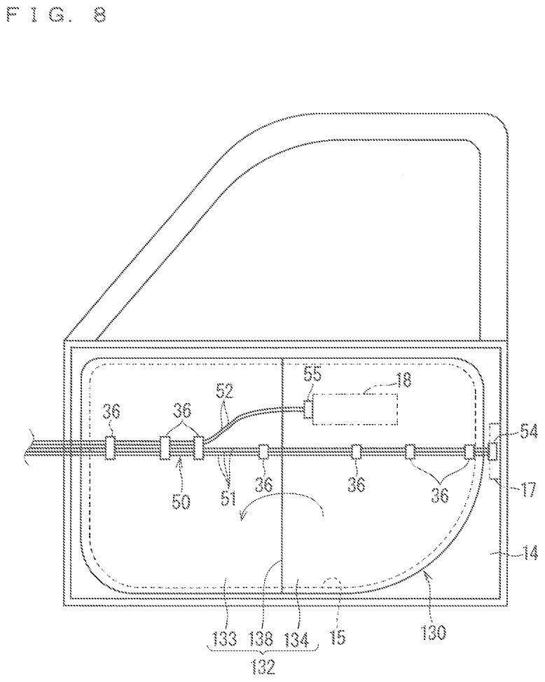

In the example described above, the rotational axis of the hinge part 38 extends along the longitudinal direction of the door 10 (an anterior-posterior direction of the vehicle), however, this configuration is not necessary. For example, as with a door wiring module 130 in the example illustrated in FIG. 8, a rotational axis of a hinge part 138 extends along a height direction of the door 10. In this case, a plurality of assembled parts 133 and 134 of a door planar member 132 are disposed separately in the longitudinal direction of the door 10 (the anterior-posterior direction of the vehicle). In the example illustrated in FIG. 8, one of the plurality of assembled parts 133 and 134 may be the first assembled part.

According to the present disclosure, the wiring member 50 is attached to the door planar member 32, thus the wiring member 50 can also be assembled at a time of assembling the door planar member 32 to the door panel 12. In the state where the first assembled part 33 is assembled to the first region in the door panel 12, the second assembled part 34 is provided to be movable from the second region in the door panel 12 so as to be able to open the part of the operation opening 15 formed in the second region, thus the operation using the operation opening 15 can be performed in this state. The second assembled part 34 is assembled to the second region after the operation, thereby being able to cover the operation opening 15 formed in the door panel 12, thus the operation or covering the operation opening 15 formed in the door panel 12 can be easily performed. According to these configurations, the operation of assembling the wiring member 50 to the door 10 and the operation of covering the operation opening 15 formed in the door 10 can be simplified.

The second assembled part 34 is beaded with respect to the first assembled part 33 by the hinge part 38 in the state where the first assembled part 33 is assembled to the door panel 12, thus the operation opening 15 formed in the door panel 12 can be opened. When the second assembled part 34 is assembled to the door panel 12 after the operation using the operation opening 15, the second assembled part 34 is bended with respect to the first assembled part 33 by the hinge part 33, thus the assembling posture can be easily achieved.

When the wiring member 50 is fixed to only one of the first assembled part 33 and the second assembled part 34, load on the wiring member 50 caused by bending, for example, is suppressed in the case where only the first assembled part 33 in the first assembled part 33 and the second assembled part 34 is assembled to the door panel 12 and the operation opening 15 formed in the door panel 12 is opened.

### Embodiment 2

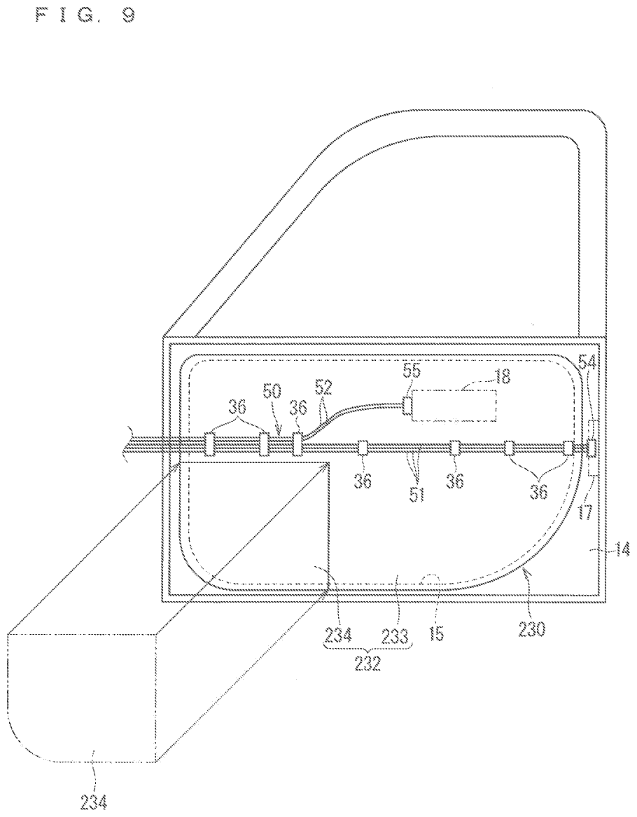

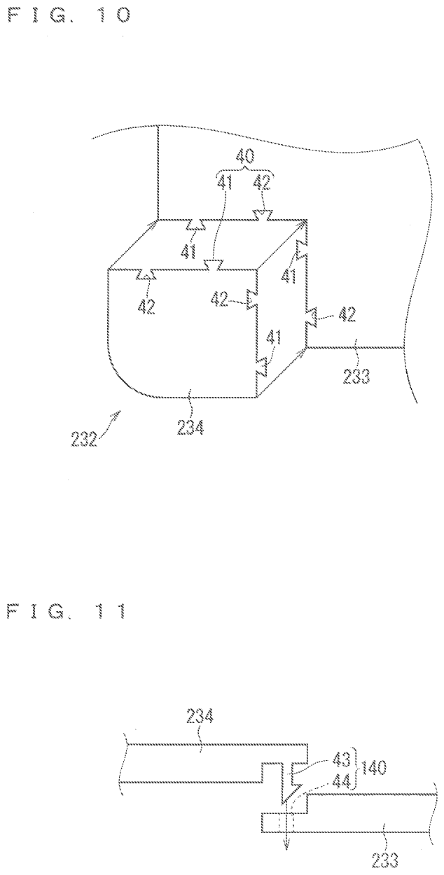

A door wiring module according to an embodiment 2 is described hereinafter. FIG. 9 is a schematic side view illustrating a door wiring module 230 according to the embodiment 2. FIG. 10 is a schematic side view illustrating a door planar member 232 in the door wiring module 230 according to the embodiment 2. In the description of the present embodiment, the same reference numerals are assigned to the similar constituent elements described above, and the description thereof will be omitted.

In the present example, a configuration of the door planar member 232 is different from that of the door planar member 32 described above. The door planar member 232 includes a first assembled part 233, a second assembled part 234, and a locking part 40 detachably connecting the first assembled part 233 and the second assembled part 234. In the present example, shapes of the first assembled part 233 and the second assembled part 234 are different from those of the first assembled part 33 and the second assembled part 34 described above. That is to say, the first assembled part 33 and the second assembled part 34 described above are formed into the shapes connected at one edge thereof, however, the first assembled part 233 and the second assembled part 234 in the present example are formed into shapes connected at a plurality of edges (herein, two) thereof. The locking part 40 is provided on each of the plurality of edges.

The locking part 40 includes a convex part 41 and a concave part 42 fitted to each other. The convex part 41 protrudes in a planar direction of the assembled part. The concave part 42 is formed to be concave in the planar direction of the assembled part. The convex part 41 includes a part gradually widened from a base end portion toward a tip end portion in a protrusion direction. The concave part 42 includes a part gradually widened from an opening portion toward a bottom portion on a side opposite from the opening portion. According to these configurations, the convex part 41 and the concave part 42 are fitted to each other and hardly come out of each other in the planar direction of the assembled part.

The convex part 41 is provided in at least one of the first assembled part 233 and the second assembled part 234, and the concave part 42 is provided in at least the other one of them. In the example illustrated in FIG. 11, the plurality of (herein, four) locking parts 40 are provided, and the convex parts 41 and the concave parts 42 in the plurality of locking parts 40 are dispersedly disposed in both the first assembled part 233 and the second assembled part 234. In the example illustrated in FIG. 11, the plurality of (herein, two) locking parts 40 are provided in one edge, and the convex parts 41 and the concave parts 42 in the plurality of (herein, two) locking parts 40 are dispersedly disposed in both the first assembled part 233 and the second assembled part 234 in one edge.

However, the shape of the locking part 40 is not limited thereto described above. An optional shape capable of locking the first assembled part 233 and the second assembled part 234 can be adopted as the locking part 40. For example, as illustrated in FIG. 11, a locking part 140 including a locking piece 43 and a locking hole 44 locked to each other may be adopted. The locking piece 43 is formed to be able to be inserted into the locking hole 44 when a wing part of the locking piece 43 is elastically deformed. When the wing part elastically recovers after passing through the locking hole 44, the locking piece 43 is locked to a peripheral edge portion of the locking hole 44, and the locking piece 43 and the locking hole 44 are locked to each other, in the example illustrated in FIG. 11, an insertion direction of the locking piece 43 inserted into the locking hole 44 is set to a thickness direction of the assembled parts 233 and 234, Needless to say, the insertion direction of the locking piece 43 inserted into the locking hole 44 may be set to a planar direction of the assembled parts 233 and 234.

According to the present disclosure, the operation opening 15 formed in the door panel 12 can be opened when the second assembled part 234 is not connected to the first assembled part 233 in the state where the first assembled part 233 is assembled to the door panel 12. When the second assembled part 234 is assembled to the door panel 12, the second assembled part 234 can be connected to the first assembled part 233 using the locking part 40, thus can be easily assembled to the door panel 12. The number of positions where the second assembled part 234 is directly fixed to the door panel 12 can be reduced.

[Additional Statement]

In the example described above, one second assembled part is connected to one first assembled part, however the plurality of second assembled parts may be connected to one first assembled part. It is also applicable that a third assembled part is further connected to the second assembled part. The third assembled part is a part formed to be able to open a part of the operation opening different from the second assembled part.

When the first assembled part and the second assembled part are formed into shapes connected at a plurality of edges, it is also applicable that one edge is connected b the locking part 40 and the other edge is connected by the hinge part 38.

In the example described above, the wiring member 50 is disposed on a side of the design trim 20 on the door planar member 32. The wiring member 50 may be disposed on a side of the inner panel 14 on the door planar member and may also be disposed on both sides of the design trim 20 and the inner panel 14.

Each configuration described in the above embodiments and modification examples thereof can be appropriately combined as long as they are not contradictory.

### EXPLANATION OF REFERENCE SIGNS

10 door

12 door panel

13 outer panel

14 inner panel

15, 115, 215, 215b operation opening

16 opening

17, 18 electrical component

20 design trim

22 door handle

24 operation part

26 window

28 window open-close jig

30, 130, 230 door wiring module

32, 132, 232 door planar member

33, 34, 133, 134, 233, 234 assembled part

35 holding groove

36 retaining part

37 protruding part

38, 138 hinge part

40, 140 locking part

41 convex part

42 concave part

43 locking piece

44 locking hole

30 wiring member

51, 52 electrical wire

54, 55 connector

80 fusion head.

B screw

S space

1. An attachment structure of a door wiring module attached to a door panel, the door wiring module comprising:
a door planar member incorporated between a door panel and a design trim to be able to cover an operation opening formed in the door panel in a door of a vehicle; and
a wiring member attached to the door planar member, wherein
the door planar member includes a first assembled part assembled to a first region in the door panel and a second assembled part assembled to a second region different from the first region in the door panel, and in a state where the first assembled part is assembled to the first region in the door panel, the second assembled part is movably provided in a position other than the second region in the door panel so as to be able to open a part of the operation opening formed in the second region,
the operation opening is partially formed in the door panel, and
only the second assembled part of a combination of the first assembled part and the second assembled part covers the operation opening.

2. The attachment structure of the door wiring module according to claim 1, wherein
the door planar member further includes a hinge part connecting the first assembled part and the second assembled part to be able to relatively bend the first assembled part and the second assembled part in a front-back direction.

3. The attachment structure of the door wiring module according to claim 1, wherein
the door planar member further includes a locking part detachably connecting the first assembled part and the second assembled part.

4. The attachment structure of the door wiring module according to claim 1, wherein
the wiring member is fixed to only one of the first assembled part and the second assembled part.
